(19) United States
(12) Patent Application Publication
(10) Pub. No.: US 2024/0323011 A1
(43) Pub. Date: Sep. 26, 2024

(54) SYSTEM AND METHOD FOR WEB ACCESS WITH CONTACTLESS CARD

(71) Applicant: Capital One Services, LLC, McLean, VA (US)

(72) Inventors: Jeffrey RULE, Chevy Chase, MD (US); Jason JI, Reston, VA (US); Colin HART, Falls Church, VA (US); Wayne LUTZ, Fort Washington, MD (US)

(21) Appl. No.: 18/124,516

(22) Filed: Mar. 21, 2023

(51) Int. Cl. H04L 9/08; H04L 9/30

(52) U.S. Cl. CPC H04L 9/088; H04L 9/30

(57) ABSTRACT

Systems and methods for accessing a web application through a contactless card are provided. The systems include a contactless card, a user device, and a server. The methods comprise tapping a card to a user device, directing the user device to a server associated with a web application, transmitting an authentication credential, validating the credential, and allowing the user device to access the web application.

### FIELD OF DISCLOSURE

This invention relates generally to accessing web applications with a contactless card.

### BACKGROUND

Mobile or web applications are often used to confirm a mobile user's identity. For example, a user may want to make a purchase from a website. To confirm the user's identity, the website sends the user a uniform resource locator (URL) link. The user clicks the link and is directed to a separate website or mobile application where the user is prompted with a one-time-password. This two-factor authentication adds an extra layer of security and helps prevent fraudulent parties from buying products using the user's stolen information.

However, this conventional method is time-consuming. Typing in a second method of authentication can be slow and frustrating for the user. Also, this method can be insecure. An unauthorized party can intercept the one-time password over a network, or he can simply steal a user's phone. A quicker, more secure method is needed for accessing web applications.

These and other deficiencies exist. Therefore, there is a need to provide systems and methods that overcome these deficiencies and provide for secure authentication.

### SUMMARY OF THE DISCLOSURE

Embodiments of the present disclosure provide a system for the dynamic direction of a user device to a URL, the system comprising a user device, a card, and a server. The server further comprises a memory, and a processor. The processor is configured to open a communication field between the user device and the card, then transmit, from the card to the user device, a request to direct the user device to the server, the request further comprising a personal identity code associated with the owner of the user device and a uniform resource locator (URL) associated with a predetermined website. Then, the processor directs the user device to the server. Next, the processor receives, from the server, an authentication request and transmits, to the server, an authentication credential. Then, the processor validates the authentication credential and directs the user device to the website associated with the URL.

Embodiments of the present disclosure provide a method for the dynamic direction of a user device to a URL, the method comprising opening, by a processor, a communication field between a user device and a card; transmitting, from the card to the user device, a request to direct the user device to a server, the request further comprising a personal identity code associated with an owner of the user device and a uniform resource locator (URL) associated with a predetermined website; directing, by the processor, the user device to the server; receiving, from the server, an authentication request; transmitting, to the server, an authentication credential; validating, by the processor, the authentication credential; and directing, by the processor, the user device to the website associated with the URL.

Embodiments of the present disclosure a computer readable non-transitory medium comprising computer executable instructions that, when executed on a processor, perform procedures comprising the steps of: opening, by a processor, a communication field between a user device and a card; transmitting, from the card to the user device, a request to direct the user device to a server, the request further comprising a personal identity code associated with an owner of the user device and a uniform resource locator (URL) associated with a predetermined website; directing, by the processor, the user device to the server; receiving, from the server, an authentication request; transmitting, to the server, an authentication credential; validating, by the processor, the authentication credential; and directing, by the processor, the user device to the website associated with the URL.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a diagram illustrating a contactless card according to an exemplary embodiment.

FIG. 3 is a diagram illustrating a contact pad of a contactless card according to an exemplary embodiment.

FIG. 4 is a method flowchart illustrating a method of cryptography according to an exemplary embodiment.

FIG. 5 is a diagram illustrating a near field communication (NFC) field according to an exemplary embodiment.

FIG. 6 is a flowchart illustrating a process according to an exemplary embodiment.

FIG. 7 is a flowchart illustrating a process according to an exemplary embodiment.

FIG. 8 is a flowchart illustrating a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiments can be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments of the present disclosure include systems and methods for using a contactless card to access a web application. Generally, the systems include a contactless card, a user device such as a smart phone, and a server. The contactless card can be preconfigured with a URL-request (or other link request) and a personal ID datum. The user may tap the contactless card to the user device. In response, the user device reads the information and directs the user device to the web application. Before allowing access, the web application requests the user to validate himself. To perform the validation, the user device opens a communication field such as an NFC field. The contactless card enters the NFC field and shares an authentication credential. This credential may be without limitation a digital signature or a diversified key exchange. After receiving the authentication credential, the server validates the credential and allows the user to access the web application.

Exemplary embodiments offer many improvements over conventional systems and methods. For example, exemplary embodiments offer a quicker way for users to access a website or application. Rather than type in a URL on a search engine or manually to find a desired web application, the user can simply tap their contactless card to their user device, saving time and improving the user experience.

Furthermore, exemplary embodiments reduce user error and frustration. For example, a user may have trouble finding the website or web application on their user device, but exemplary embodiments avoid frustrating the user and wasting time in this manner.

The present embodiments also offer an improvement of security over conventional systems and methods. By implementing an NFC field to transmit an authentication credential, the system significantly reduces the chances of an interfering party stealing the credential. Additionally, the authentication credential can be encrypted, further improving security.

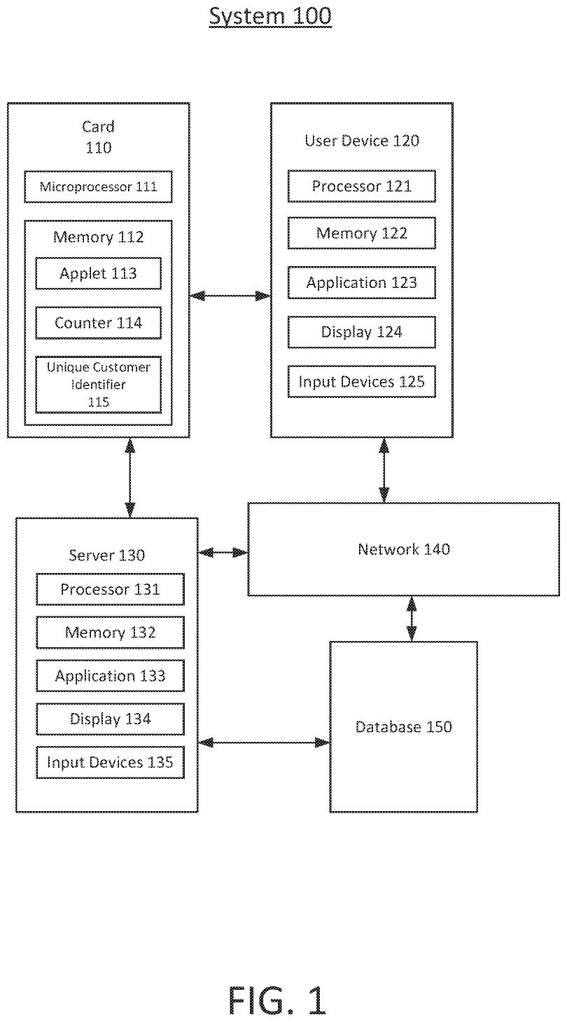

FIG. 1 is a block diagram illustrating a system according to an exemplary embodiment. FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

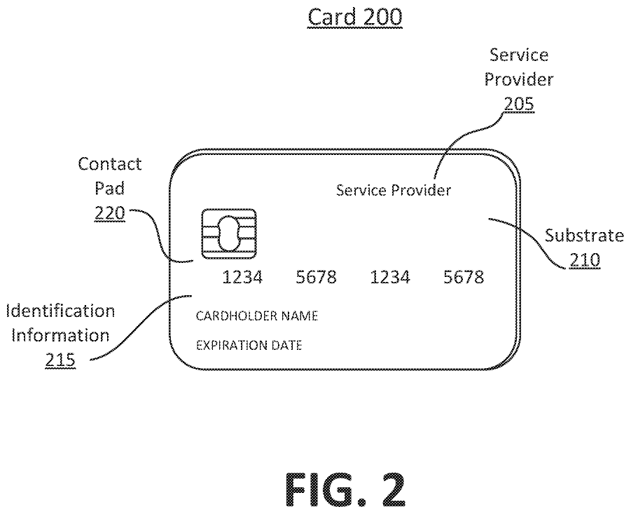

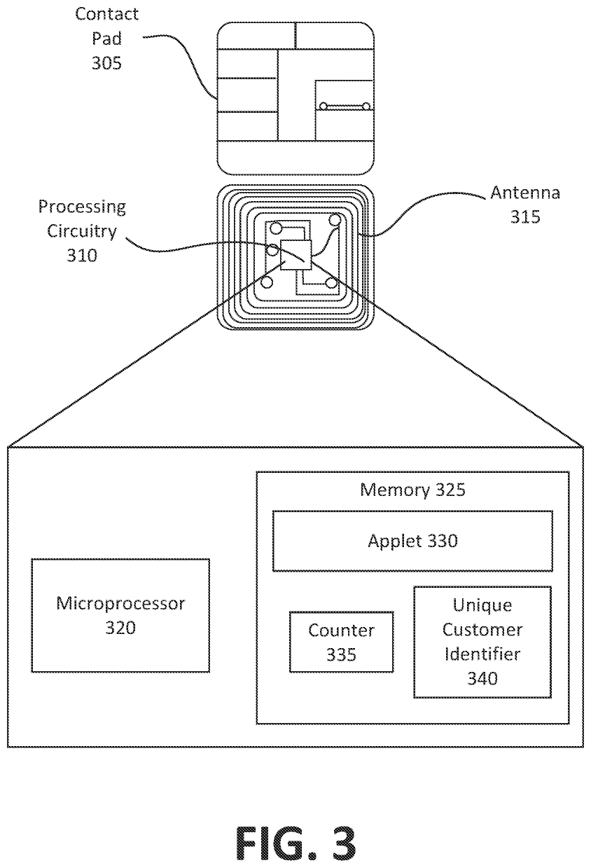

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the card 110, retaining a web session between the user device 120 and the card 110, and masking private data received from the user device 120 and the card 110. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the card 110. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 is a diagram of a card according to an exemplary embodiment.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2 and FIG. 3. These components may be located behind the contact pad 220 or elsewhere on the substrate 210. The contactless card 200 may also include a magnetic strip or tape, which may be located on the back of the card (not shown in FIG. 2).

FIG. 3 illustrates a contact pad 305 of a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet, and perform the functions described herein. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NFC Data Exchange Format (NDEF) message that comprises a cryptographically secure OTP encoded as an NDEF text tag.

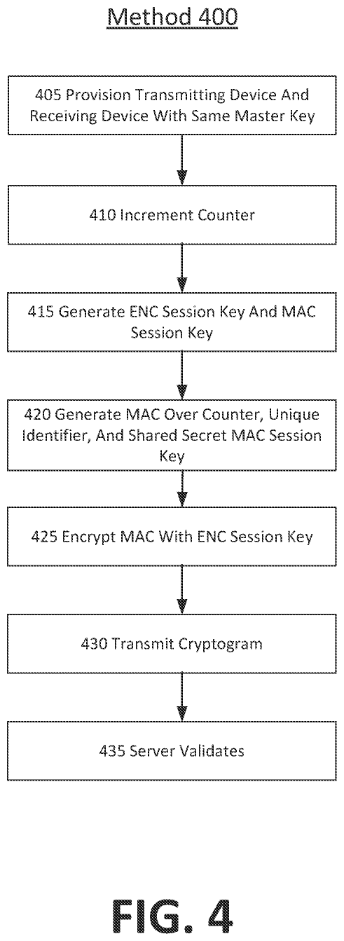

FIG. 4 is a flow chart of method 400 of key diversification according to an exemplary embodiment.

In some examples, a sender and recipient may desire to exchange data via a transmitting device and a receiving device. In some embodiments, the transmitting device is the contactless card and the receiving device is the server. It is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like. The transmitting device and the receiving device may be network-enabled computer devices. In some examples, the transmitting device may comprise a contactless card and the receiving device may comprise a server. In other examples, the receiving device may comprise a user device or a user device application.

The method 400 can begin with action 405. In action 405, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 410, the transmitting device may take the selected cryptographic algorithm, and using the master symmetric key, process the counter value. For example, the transmitting device may select a symmetric encryption algorithm, and use a counter which updates with every conversation between the transmitting device and the receiving device. The one or more counters may comprise a numeric counter sufficient to store an integer. The transmitting device may increment the counter one or more times.

In step 415, the transmitting device generates two session keys: one ENC (encryption) session key and one MAC (message authentication code) session key. The transmitting device may encrypt the counter value with the selected symmetric encryption algorithm using the master symmetric key to create a session key.

In step 420, the transmitting device generates the MAC over the counter, the unique customer identifier, and the shared secret MAC session key. The customer identifier may comprise a unique alphanumeric identifier assigned to a user of the contactless card, and the identifier may distinguish the user of the contactless card from other contactless card users. In some examples, the customer identifier may identify both a customer and an account assigned to that customer and may further identify the contactless card associated with the customer's account.

In step 425, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 430, the transmitting device transmits a cryptogram to the receiving device. The cryptogram can include the applet information, the unique customer identifier, the counter value, and the encrypted MAC.

In step 435, the receiving device validates the cryptogram.

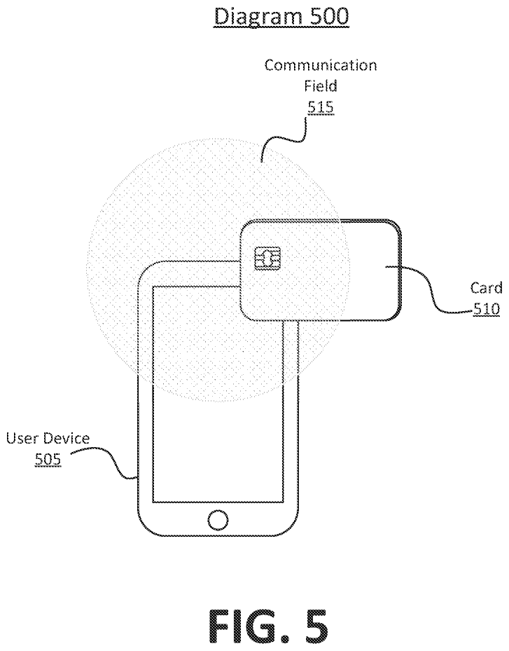

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats, and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the card are in close contact with each other so that they can exchange information within the communication field.

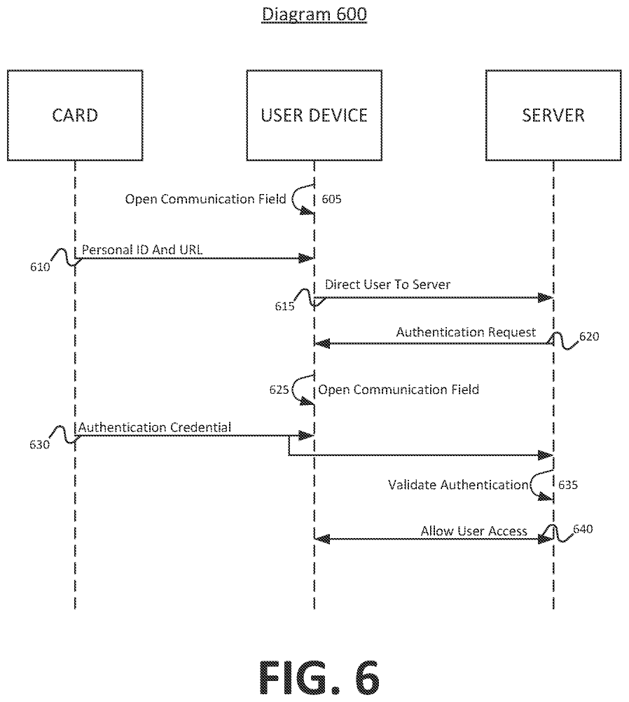

FIG. 6 illustrates the diagram 600 describing a sequence according to an exemplary embodiment. The sequence can include a contactless card, a user device, and a server. These elements are explained further with reference to FIGS. 1-3 and 5.

In action 605, the user device opens a communication field. This action can be performed by a processor associated with the user device. The user device can include but is not limited to a smart phone, tablet, computer, or smart watch. The communication field can be Bluetooth, a near field communication (NFC) field, a RFID-compatible field, or some other communication field.

In action 610, the user can bring the contactless card within the communication field opened by the user device. The contactless card can include but is not limited to a card associated with an account holder at a banking institution or an account holder of a spending account, savings account, or growth account. Upon entering the communication field, the contactless card can transmit a predetermined set of information to the user device. The information can include a personal ID (identifier) and URL-request associated with the contactless card. The personal ID can be the unique customer identifier explained with further reference to FIG. 3, or the personal ID can be some other personal identification datum unique to the contactless card. For example, the personal ID can be associated with an email, phone number, contactless card information, driver's license number, passport number, birthdate, or some other personal information associated with the user or owner of the user device or user device application. In some embodiments, the personal ID can be dynamically generated based on the user's transaction history, spending habits, or some other historical or behavioral data. For example, the user may often shop at amazon.com. After the user has visited amazon.com for a predetermined time period or after a predetermined number of visits, the user device application or the server can associate the personal ID with amazon.com. Later, the user device application or server can change the destination URL to some other site if the user changes their spending habits. The user device application can also associate the personal ID with a particular software application or web application. In other embodiments, the user can independently change the destination URL through the user device application. After the personal ID has been transmitted to the server, a copy of the personal ID can be stored in a memory or database associated with the server. The URL-request can be stored on the memory associated with the contactless card. The contactless card may hold one or more URL-requests. The URL-request can be associated with a predetermined website or web application.

In action 615, the user device directs the user to a server. This action can be performed in response to the user device receiving a personal ID and URL-request from the contactless cad. The server can be associated with a predetermined website or web application. Additionally, the server may be related to the website associated with the URL-request from the contactless card.

In action 620 the server can transmit an authentication request to the user device. The authentication request may be transmitted over a network. The authentication request can be transmitted by a short message service (SMS), multimedia message service (MMS), or in some other suitable manner.

In action 625, the user device can open a communication field. This action can be performed in response to receiving an authentication request from the server. The communication field can be Bluetooth, a near field communication (NFC) field, a RFID-compatible field, or some other communication field.

In action 630, the contactless card can transmit an authentication credential to the user device upon entering the communication field. The authentication credential can be associated with a private key and public key exchange between the contactless card and the user device. The contactless card can be configured with a private key. The private key can be transmitted to the user device, which in turn transmits it to server which is configured with the public key. This diversified key exchange can be the same process explained with further reference to FIG. 4. Additionally, the authentication credential can include a digital signature from the contactless card.

In other embodiments, an authentication credential may vary in form. For example, the authentication credential can be a password, personal identification number (PIN), fingerprint scan, facial scan, voice recognition, or some other biometric.

In action 635, the server can validate the authentication credential sent by the contactless card. This action can be performed by a processor or predetermined algorithm associated with the server. In action 640, the server allows the user device to access the website, web application, or mobile application associated with the URL request. This action can be performed in response to validating the authentication credential from the contactless card.

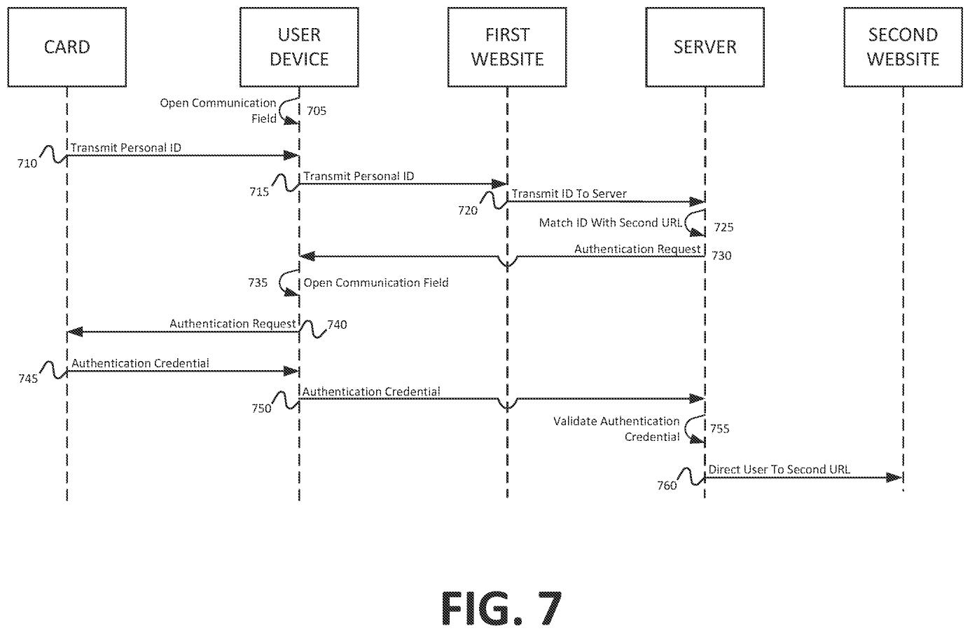

FIG. 7 is a flowchart illustrating a process according to an exemplary embodiment. In some embodiments, the card can be provisioned with one or more user identification data (personal identifier) as well as a URL. The URL may be read only or read and write capable. The user can provision the URL to direct the user device to a first website, at which point a server will match the personal ID with a second URL. In directing the user to their desired second URL via a first URL, the process makes it easier for the user to change the second URL dynamically.

The process can begin with action 705 in which the user device, by a processor, open a communication field. The communication field can be Bluetooth, an NFC field, a RFID-compatible field, or some other communication field. The user device and associated processor are discussed with further reference to FIG. 1.

In action 710, the contactless card can transmit one or more user identification data or personal ID, as well as a first URL link or information packet. The contactless card is discussed with further reference to FIGS. 2 and 3. The personal ID can include without limitation: personal information such as name, address, and phone number; account information such as card account, security code, card verification value (CVV), payment card number (PCN), and expiration date; unique customer identifier; or some other unique user data. For example, the personal ID can be associated with an email, phone number, contactless card information, driver's license number, passport number, birthdate, or some other personal information associated with the user or the owner of the user device or user device application. In some embodiments, the personal ID can be changed dynamically by the user. As a nonlimiting example, a user's current personal ID might ultimately direct the user device to an online shopping website or online shopping application. However, the user can change the personal ID such that the ultimate destination is a streaming website. This change can be implemented via a user device application or user profile managed by a separate server or processor. This change can be implemented by either or both changed the personal ID itself or merely changing the URL associated with the personal ID via a website or application. In some embodiments, the personal ID can be dynamically generated based on the user's transaction history, spending habits, or some other historical or behavioral data. For example, the user may often shop at amazon.com. After the user has visited amazon.com for a predetermined time period or after a predetermined number of visits, the user device application or the server can associate the personal ID with amazon.com. Later, the user device application or server can change the destination URL to some other site if the user changes their spending habits. The user device application can also associate the personal ID with a particular software application or web application. In other embodiments, the user can independently change the destination URL through the user device application.

After the personal ID has been transmitted to the server, a copy of the personal ID can be stored in a memory or database associated with the server. The URL-request can be stored on the memory associated with the contactless card. The contactless card may hold one or more URL-requests. The URL-request can be associated with a predetermined website or web application. The personal ID and URL can be transmitted from the card to the user device over the communication field.

In action 715, the user device can direct the user to a first website. The user device can transmit the personal ID to the first website. In some embodiments, the first website can be a generic or universal website designed to receive a personal ID and redirect the user device, via one or more servers, to a second website.

Having received the personal ID and URL, the first website in action 720 can transmit the personal ID to one or more servers. It is understood that the first and second websites can themselves be associated with their own servers or the same server illustrated in FIG. 7. In action 725, the server can match the personal ID with a second URL on file. For example, the server can be provisioned with a list of personal IDs and associated URLs. The server can first determine whether the personal ID matches any personal ID on file. Then, if there is a match, the server can find which URL (in this case the second URL) associated with the personal ID. In some embodiments, one or more URLs can be associated with each personal ID. The second URL goes to a separate website than first URL.

Having matched the personal ID with a second URL, the server in action 730 can transmit an authentication request to the user device. This request can be transmitted over, e.g., a network.

In response to receiving the authentication request, the user device in action 735 can open a communication field. The communication field can be Bluetooth, a near field communication (NFC) field, a RFID-compatible field, or some other communication field. The communication field in action 735 can be a new or otherwise separate communication field from the communication field described in action 705.

Upon opening the communication field, the user device in action 740 can transmit an authentication request in action 740. This authentication request in action 740 can be the same authentication request from action 730 or a different authentication request sufficient that is otherwise directed at requesting a sufficient authentication credential.

In response to the authentication request, the card can transmit an authentication credential to user device in action 745. The authentication credential can include without limitation a unique customer identifier, a counter value, or a digital signature including a signature from a private key provisioned to the card. The card can transmit the authentication credential to the user device over the communication field. In other embodiments, the card can transmit the authentication credential over a wireless network directly to the server. In other embodiments, other credential can include without limitation a password, personal identification number (PIN), one time password sent via short message (SMS), or a biometric including fingerprint, facial scan, voice scan, or writing sample. In other embodiments, the authentication credential can be an encrypted message authentication code (MAC) discussed with further reference to FIG. 4.

In action 750, the user device can transmit the authentication credential to the server. This action can be performed by a processor associated with the user device. Having received the authentication credential, the server in action 755 can validate the authentication credential. In some embodiments, the server can validate the authentication credential by matching the credential with a credential on file. In other embodiments, the server can be provisioned with a public key that validates the digital signature credential. In other embodiments, the server can decrypt the MAC to validate the credential. Having validated the authentication credential, in action 760 directs the user to website associated with the second URL. This action can be performed by a processor associated with the server.

In both FIG. 6 and FIG. 7, an application programming interface (API) may be present to facilitate the direction of the user device to the desired URL (first or second URL). An API is a source code interface that a computer system or program library provides in order to support requests for services from a software application. An API is specified in terms of a programming language that can be interpretative or compiled when an application is built, rather than an explicit low-level description of how data is laid out in memory. The software that provides the functionality described by an API is said to be an implementation of the API.

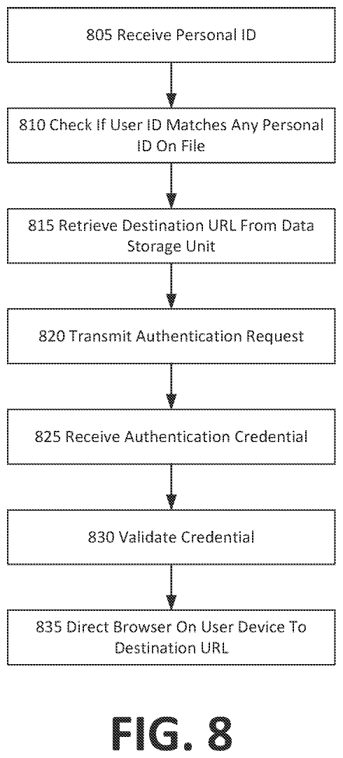

FIG. 8 is a flowchart illustrating a process according to an exemplary embodiment. In some embodiments, the destination can be retrieved from a data storage unit, database, or some other memory. By retrieving the destination URL from a data storage unit, the process can more quickly provide the URL to the user. The URL may be read only or read and write capable.

In action 805, the server can receive a personal ID. The server can receive the personal ID from the user device or from a third-party server or processor. In some embodiments, the server can receive the personal ID directly from the contactless card.

In action 810, the server checks if the personal ID matched any personal ID on file. The server can be provisioned with a list of personal IDs that have been provided at some earlier time or otherwise associated with accounts related to the contactless card. In some embodiments, the server can interact with some other server to determine if the personal ID has been provided elsewhere. In some embodiments, the personal ID can be dynamically generated based on the user's transaction history, spending habits, or some other historical or behavioral data. For example, the user may often shop at amazon.com. After the user has visited amazon.com for a predetermined time period or after a predetermined number of visits, the user device application or the server can associate the personal ID with amazon.com. Later, the user device application or server can change the destination URL to some other site if the user changes their spending habits. The user device application can also associate the personal ID with a particular software application or web application. In other embodiments, the user can independently change the destination URL through the user device application.

Upon confirming that there is a personal ID on file, the server in action 815 can retrieve a destination URL from a data storage unit. This action can be performed by a processor associated with the server. A destination URL is the URL that the user wants to ultimately arrive at. It is understood that the destination URL described in FIG. 8 can be the same as the second URL described in FIG. 7 or the URL described in FIG. 6. The data storage unit can be provided the destination URL from an earlier registration process as a nonlimiting example. Once the destination URL has been retrieved, the server in action 820 can transmit an authentication request to the user device over a network.

In action 825, the server can receive an authentication credential. In some embodiments, the server can receive the authentication credential directly from the user's contactless card. Having received the authentication credential, the server can validate the credential in action 830. In some embodiments, the server can validate the authentication credential by matching the credential with a credential on file. In other embodiments, the server can be provisioned with a public key that validates the digital signature credential. In other embodiments, the server can decrypt the MAC to validate the credential.

In action 835, the server can direct a browser to the destination URL. The browser can be currently open on the user device. In other embodiments, the server can open the browser via the user device or some user device application.

In some aspects, the techniques described herein relate to a system for dynamic direction of a user device to a URL, the system including: a card; and a server, the server further including: a memory, and a processor configured to: open a communication field, receive, from the card via the communication field, a request to direct a user device application to the server, the request further including a personal identity code associated with an owner of a user device associated with the user device application and a uniform resource locator (URL) associated with a predetermined website, direct the user device application to the server, receive, from the server, an authentication request, transmit, to the server, an authentication credential, validate the authentication credential, and direct the user device application to the website associated with the URL.

In some aspects, the techniques described herein relate to a system, wherein the processor is further configured to: open, upon receiving an authentication request from the server, a second communication field, and perform a diversified key exchange between the card and the server, the card further configured with a private key and the server further configured with a public key.

In some aspects, the techniques described herein relate to a system, wherein the user device associated with the user device application is at least one selected from the group of a smart phone, tablet, or computer.

In some aspects, the techniques described herein relate to a system, wherein the authentication credential is a password or PIN number.

In some aspects, the techniques described herein relate to a system, wherein the authentication credential is a biometric fingerprint scan, facial scan, or voice recognition.

In some aspects, the techniques described herein relate to a system, wherein the predetermined URL can be changed manually by the user on the user device.

In some aspects, the techniques described herein relate to a system, wherein the personal identity code is associated with an email, phone number, or card information.

In some aspects, the techniques described herein relate to a system, wherein the card is further configured with a private key and the server is further configured with a public key.

In some aspects, the techniques described herein relate to a system, wherein the card is a contactless card associated with an account holder at a banking institution.

In some aspects, the techniques described herein relate to a method for directing a user device to a predetermined URL, the method including the steps of: opening, by a processor, a communication field; transmitting, by the processor over the communication field, a request to direct a user device application to a server, the request further including a personal identity code associated with an owner of a user device associated with the user device application and a uniform resource locator (URL) associated with a predetermined website; directing, by the processor, the user device application to the server; receiving, from the server, an authentication request; transmitting, to the server, an authentication credential; validating, by the processor, the authentication credential; and directing, by the processor, the user device application to the website associated with the URL.

In some aspects, the techniques described herein relate to a method, wherein the method further includes the steps of: opening, upon receiving an authentication request from the server, a second communication field; and performing a diversified key exchange between a card and the server, the card further configured with a private key and the server further configured with a public key.

In some aspects, the techniques described herein relate to a method, wherein the user device is a smart watch.

In some aspects, the techniques described herein relate to a method, wherein the personal identity code is a driver's license number, passport number, or birth date.

In some aspects, the techniques described herein relate to a method, wherein the communication field is Bluetooth, a near field communication (NFC) field, or a Radio Frequency Identification (RFID)-compatible field.

In some aspects, the techniques described herein relate to a method, wherein in the card is a contactless card associated with an account holder of a spending account, savings account, or growth account.

In some aspects, the techniques described herein relate to a method, wherein the steps further include transmitting the authentication request by a short message service (SMS) or a multimedia message service (MMS).

In some aspects, the techniques described herein relate to a method, wherein the steps further include directing the user device to a mobile application associated with the URL.

In some aspects, the techniques described herein relate to a method, wherein the authentication credential is a digital signature from the card.

In some aspects, the techniques described herein relate to a computer readable non-transitory medium including computer executable instructions that, when executed on a processor, perform procedures including the steps of: opening, by a processor, a communication field; transmitting, from a card to a user device application, a request to direct the user device application to a server, the request further including a personal identity code associated with an owner of a user device associated with the user device application and a uniform resource locator (URL) associated with a predetermined website; directing, by the processor, the user device application to the server; receiving, from the server, an authentication request; transmitting, to the server, an authentication credential; validating, by the processor, the authentication credential; and directing, by the processor, the user device application to the website associated with the URL.

In some aspects, the techniques described herein relate to a computer readable non-transitory medium, wherein a copy of the personal identity code is stored in a memory associated with the server.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

In the preceding specification, reference is made to a uniform resource locator (URL) link. However it is understood that the present disclosure is not limited thereto and can include other types of links, including without limitation, uniform resources identifiers (URIs) hyperlinks, and other data references.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for dynamic direction of a user device to a URL, the system comprising:
a card; and
a server, the server further comprising:
a memory, and
a processor configured to:
open a communication field,
receive, from the card via the communication field, a request to direct a user device application to the server, the request further comprising a personal identity code associated with an owner of a user device associated with the user device application and a uniform resource locator (URL) associated with a predetermined website,
direct the user device application to the server,
receive, from the server, an authentication request,
transmit, to the server, an authentication credential,
validate the authentication credential, and
direct the user device application to the website associated with the URL.

2. The system of claim 1, wherein the processor is further configured to:
open, upon receiving an authentication request from the server, a second communication field, and
perform a diversified key exchange between the card and the server, the card further configured with a private key and the server further configured with a public key.

3. The system of claim 1, wherein the user device associated with the user device application is at least one selected from the group of a smart phone, tablet, or computer.

4. The system of claim 1, wherein the authentication credential is a password or PIN number.

5. The system of claim 1, wherein the authentication credential is a biometric fingerprint scan, facial scan, or voice recognition.

6. The system of claim 1, wherein the predetermined URL can be changed manually by the user on the user device.

7. The system of claim 1, wherein the personal identity code is associated with an email, phone number, or card information.

8. The system of claim 1, wherein the card is further configured with a private key and the server is further configured with a public key.

9. The system of claim 1, wherein the card is a contactless card associated with an account holder at a banking institution.

10. A method for directing a user device to a predetermined URL, the method comprising the steps of:
opening, by a processor, a communication field;
transmitting, by the processor over the communication field, a request to direct a user device application to a server, the request further comprising a personal identity code associated with an owner of a user device associated with the user device application and a uniform resource locator (URL) associated with a predetermined website;
directing, by the processor, the user device application to the server;
receiving, from the server, an authentication request;
transmitting, to the server, an authentication credential;
validating, by the processor, the authentication credential; and
directing, by the processor, the user device application to the website associated with the URL.

11. The method of claim 10, wherein the method further comprises the steps of:
opening, upon receiving an authentication request from the server, a second communication field; and
performing a diversified key exchange between a card and the server, the card further configured with a private key and the server further configured with a public key.

12. The method of claim 10, wherein the user device is a smart watch.

13. The method of claim 10, wherein the personal identity code is a driver's license number, passport number, or birth date.

14. The method of claim 10, wherein the communication field is Bluetooth, a near field communication (NFC) field, or a Radio Frequency Identification (RFID)-compatible field.

15. The method of claim 11, wherein in the card is a contactless card associated with an account holder of a spending account, savings account, or growth account.

16. The method of claim 10, wherein the steps further comprise transmitting the authentication request by a short message service (SMS) or a multimedia message service (MMS).

17. The method of claim 10, wherein the steps further comprise directing the user device to a mobile application associated with the URL.

18. The method of claim 11, wherein the authentication credential is a digital signature from the card.

19. A computer readable non-transitory medium comprising computer executable instructions that, when executed on a processor, perform procedures comprising the steps of:
opening, by a processor, a communication field;
transmitting, from a card to a user device application, a request to direct the user device application to a server, the request further comprising a personal identity code associated with an owner of a user device associated with the user device application and a uniform resource locator (URL) associated with a predetermined website;
directing, by the processor, the user device application to the server, receiving, from the server, an authentication request;
transmitting, to the server, an authentication credential;
validating, by the processor, the authentication credential; and
directing, by the processor, the user device application to the website associated with the URL.

20. The computer readable non-transitory medium of claim 19, wherein a copy of the personal identity code is stored in a memory associated with the server.
